(19) United States
(12) Patent Application Publication
(10) Pub. No.: US 2019/0286108 A1
(43) Pub. Date: Sep. 19, 2019

(54) SYSTEM FOR THE VIRTUAL ASSISTANCE OF AN OPERATOR FOR WOOD PROCESSING MACHINES

(71) Applicant: HOMAG GmbH, Schopfloch (DE)

(72) Inventors: Michael ZETZSCHE, Albstadt (DE); Marco ROBBE, Lemgo (DE); Jan BERGMANN, Lemgo (DE); Marc WORM, Schopfloch (DE)

(21) Appl. No.: 16/357,078

(22) Filed: Mar. 18, 2019

(30) Foreign Application Priority Data
Mar. 19, 2018 (DE) 10 2018 204 152.0

(51) Int. Cl. G05B 19/4155; G06F 1/16; G06F 3/01; H04B 1/3827; G09B 19/00

(52) U.S. Cl. CPC G05B 19/4155; G06F 1/163; G06F 3/011; G06F 3/167; G09B 19/003; G05B 2219/40131; G06F 3/017; H04B 1/385

(57) ABSTRACT

A system (1) for the virtual assistance of an operator of a processing apparatus (B1, B2, B3) for processing workpieces (W) which preferably consist at least in sections of wood, wood materials, synthetic material or the like, comprising: a mobile terminal device (10) which is configured to be worn by the operator, and that has:
position detection means (11) which are configured to detect data for determining the position of the mobile terminal device (10) in relation to the processing apparatus (B1, B2, B3), information output means (12) which are configured to output information and/or operational instructions to the operator, and a preferably wireless data transmission interface (13) which is configured to communicate with a data server (20).

### TECHNICAL FIELD

This invention relates to a system for the virtual assistance of an operator of a processing apparatus for processing workpieces which preferably consist at least in sections of wood, wood materials, synthetic material or the like.

### PRIOR ART

In the field of the furniture and components industry, increasingly more complex machines are used for the processing and finishing of workpieces. These machines fulfill various tasks, from format machining and surface coating to pre-assembly and assembly. In this regard, the machines must meet very high requirements as to precision and performance, which leads to increasingly more complex systems. These complex systems demand increased qualifications of the respective operator since detailed knowledge of the mechanical and electronic structure of the machines is required for the set-up, operation, maintenance and repair of the machines.

In practice, this leads to the fact that increasingly high demands are placed on the qualifications of the operating personnel. Moreover, the risk of errors when handling the machine increases owing to the complexity, which can reduce efficiency and operational safety of the respective machine.

### DESCRIPTION OF THE INVENTION

The object of the present invention is thus to provide a system and a method for the virtual assistance of an operator of the type as described above, which simplifies the handling of the processing apparatus and increases the efficiency and operational safety of the processing apparatus. Handling is to be understood as various tasks such as, in particular, set-up, operation, maintenance, repair, etc.

According to the invention, this object is solved by a system for the virtual assistance of an operator according to claim 1 as well as a method for the virtual assistance of an operator according to claim 12. Particularly preferred embodiments of the invention are indicated in the dependent claims.

The invention is based on the idea of always providing the operator with the customized assistance which is required in precisely the current context and is expedient. For this purpose, the system according to the invention for the virtual assistance of an operator of a processing apparatus for processing workpieces which preferably consist at least in sections of wood, wood materials, synthetic material or the like has a mobile terminal device which is configured to be worn by the operator. The mobile terminal device comprises position detection means which are configured to detect data for determining the position of the mobile terminal device in relation to the processing apparatus, information output means which are configured to output information and/or operational instructions to the operator, and a preferably wireless data transmission interface which is configured to communicate with a data server.

Owing to the position detection means, the system according to the invention is always able to exactly provide the operator with the information or operational instructions which are appropriate and relevant for the current position of the operator at the processing apparatus. At the same time, the information output means make it possible to provide the operator with the respective information or operational instructions in an integrated and comprehensible manner. The preferably wireless data transmission interface thereby makes it possible to access a large pool of information or operational instructions which are stored on a data server.

As a result, the system according to the invention enables a significantly simplified operation of a potentially complex processing apparatus. Not only does this enable a potentially less-trained operator to be employed, but rather also increases the efficiency and operational safety of the processing apparatus, in particular since the probability of operational errors (including errors during set-up, operation, maintenance, repair, etc.) can be significantly reduced.

Although the system according to the invention can also provide information and/or operational instructions for the operator, independently of his position, it is provided in accordance with a further development of the invention that the data transmission interface is configured to transmit position data detected by the position detection means to the server and/or to receive information and/or operational instructions obtained from the data server for transfer to the information output means. In this way, the precise allocation of information and/or operational instructions, on the one hand, and the affected or relevant areas or components of the processing apparatus, on the other hand, is made possible. This also contributes to a simple and simultaneously safe operability of the processing apparatus.

For this purpose, it is provided in accordance with a further development of the invention that the information output means are configured to output information and/or operational instructions with reference to the processing apparatus. It is thus immediately apparent to the operator to which areas or components of the processing apparatus the information or operational instructions refer. In this regard, it is particularly preferred that the information and/or operational instructions are output together and with reference to an actual or virtual representation of the processing apparatus. This results in a particularly comprehensible form of representation in which the information or operational instructions are placed in a direct visual relation to the processing apparatus. In this manner, not only can repair and maintenance processes be reliably guided, the training of an operator can also take place at the respective processing apparatus, for example.

The information output means can be realized in various ways within the scope of the present invention. In accordance with a preferred embodiment of the invention, however, the information output means are selected from image output means, sound output means and touch output means, in particular vibration output means. Depending on the case of application, the type of information output means can have specific advantages. As such, complex situations are best shown through image output means. Sound output means are often suited to simpler information, but have the advantage of attracting the operator's attention more effectively, and the operator can, for example, continue to work with his eyes and hands on their current task. Similar considerations also apply to the touch output means, in particular in the case of vibration output means.

The information output means can include one or several of the aforementioned output means and can be distributed to one or several components. A particularly varied and detailed as well as very discernable information output can result if, in accordance with a further development of the invention, the image output means include at least a virtual or projected representation. One example of such an image output can be with a terminal device which is worn on the head of a user in the area of the eyes, for example in the form of so-called “smart glasses”.

According to a further development of the invention, it is further provided that it has input means which are configured to receive inputs of the operator for transfer to the data transmission interface and to the data server so as to control the receipt of information and/or operational instructions. In this manner, the result is an interactive system in which the operator can retrieve the desired information and/or operational instructions which are provided by the system according to the invention in the current context. The efficiency as well as the safety of the apparatus' operation is thereby increased further.

The information input means can be realized in various ways within the scope of the present invention. For example, they can be touch input means such as, particularly, a keyboard or a touchscreen. However, sound input means can be used alternatively or additionally, such as voice recognition means, for example. Generally, these have the same advantages as the abovementioned voice output means. Further alternatively or additionally, motion detection means can also be used. In this regard, typical motion detection means are gesture detection means with which the operator can input information into the terminal device by merely moving a body part. Another type of motion detection means is a so-called virtual touchscreen in which a virtual image is generated in or projected into the field of vision of the operator, and a movement of the user is put in relation to the virtual or projected image in order to effect an information input.

The position detection means can also be realized in various ways within the scope of the present invention. However, the use of a camera has proven to be particularly advantageous, with different variants also being conceivable here, such as, for example, CCD cameras, etc. Alternatively or additionally, the position detection means can also include a GPS system or a comparable local positioning system which, for example, only receives signals inside a production hall and derives the current position on the basis thereof. Sensors are also conceivable, including thermal sensors or gyrosensors, as well as laser scanners, etc.

According to a further development of the invention, it is provided that the terminal device has means for the terminal device to be worn on the body of the operator, in particular on the arm or in the area of the head. In this manner, the operator can effortlessly read and operate the at least one terminal device, and the operator is also not hindered in his task, he has his “hands free” so to speak.

The system according to the invention is particularly effective if, in addition to the mobile terminal, it has at least one processing apparatus for processing workpieces which preferably consist at least in sections of wood, wood materials, synthetic materials or the like, and a data server which communicates with the data transmission interface of the terminal device via a data connection. The data connection can thereby occur locally (within a production plant, for example) as well as non-locally, for example via the Internet.

According to a further development of the invention, it is thereby provided that at least one processing apparatus has a machine data transmission interface which communicates with the data server via a data connection, in particular also by using the Internet. It is thus made possible that current machine information such as, for example, operation and error states, maintenance needs, repair needs or the like can also be transferred to the operator via the data server and linked to further information and/or operational instructions.

A particularly advantageous operation of the system according to the invention occurs when performing the method according to the invention, which is defined in claim 12. In this regard, data for determining the position of the mobile terminal device in relation to the processing apparatus are detected by way of the position detection means, the data are transferred to the data server via the data transmission interface, and information and/or operational instructions are obtained from the data server, and information and/or operational instructions are output by way of the information output means. Thus, the advantages explained above in relation to the system according to the invention are obtained in a particularly effective manner.

A particularly interactive and thus also safe and effective method is obtained if, in accordance with a further development of the invention, the information and/or operational instructions obtained from the data server are displayed by way of the information output means, which are selected by way of the input means.

It is thereby particularly preferred that the information and/or operational instructions relate to an actual or virtual representation of the processing apparatus and are preferably output together with this representation. This results in a particularly comprehensible and thus effective and secure manner of conveying the respective information and/or operational instructions to the operator. The reason for this is that the operator does not receive the information and/or operational instructions as an abstract message, but rather in a specific connection with the relevant component or area of the processing apparatus.

A particularly great comprehensibility is further given if, in accordance with a further development of the invention, a virtual representation includes at least an area of the processing apparatus, which is not visible in the assembled state of the processing apparatus. This means that, in a way, the operator is able to “see into the machine” or that information and/or operational instructions, which will actually only become visible in the further course of the operator's task, are already displayed to him in advance. This also results in a significant increase of efficiency and safety since the operator knows what to expect. Thus, the operator is able to make the necessary preparations for the further steps and moreover can also assess whether future situations, which would still be invisible to the operator without the system according to the invention, are to be taken into account in the further work.

In order to effectively and comprehensibly support the operator in various tasks, it is further provided in accordance with a further development of the invention that the information and/or operational instructions output by way of the information output means include individual images, image sequences and/or videos. Depending on the case of application, a comprehensible and effective briefing and instruction of the operator can thereby take place, with the operator certainly being able to select within the scope of the invention the (available) form of representation he desires for the respective case of application, as needed.

### BRIEF DESCRIPTION OF THE DRAWINGS

FIG. 1 schematically shows an embodiment of the system according to the invention for the virtual assistance of an operator;

FIG. 2 schematically shows the use of the system according to the invention on a processing apparatus for the processing of workpieces.

### DETAILED DESCRIPTION OF PREFERRED EMBODIMENTS

Preferred embodiments of the invention will be described in detail below with reference to the accompanying drawings.

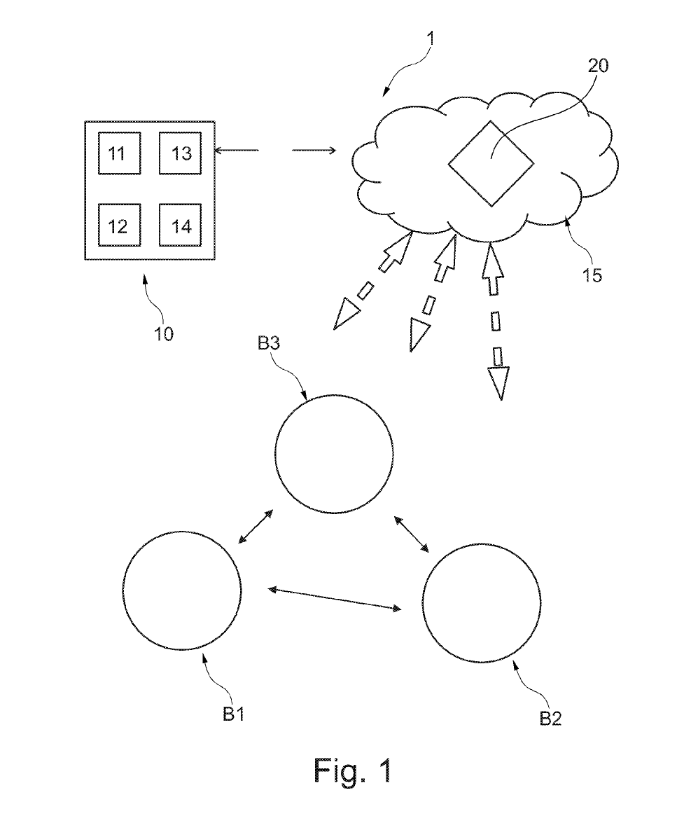

A system 1 for the virtual assistance of an operator of one or several processing apparatuses B1, B2, B3 is schematically shown in FIG. 1. In the present embodiment, the system 1 serves to assist an operator in connection with a processing apparatus B1, B2, B3 for processing workpieces W which consist at least in sections of wood, wood materials, synthetic material or the like. The processing apparatus B1, B2, B3 can thereby be various machines or installations such as, for example, apparatuses for the separation or format machining of workpieces, apparatuses for the coating or surface finishing of workpieces, apparatuses for the machining of workpieces or also apparatuses for the assembly of workpieces. These types of machines and installations are largely used in the furniture and components industry.

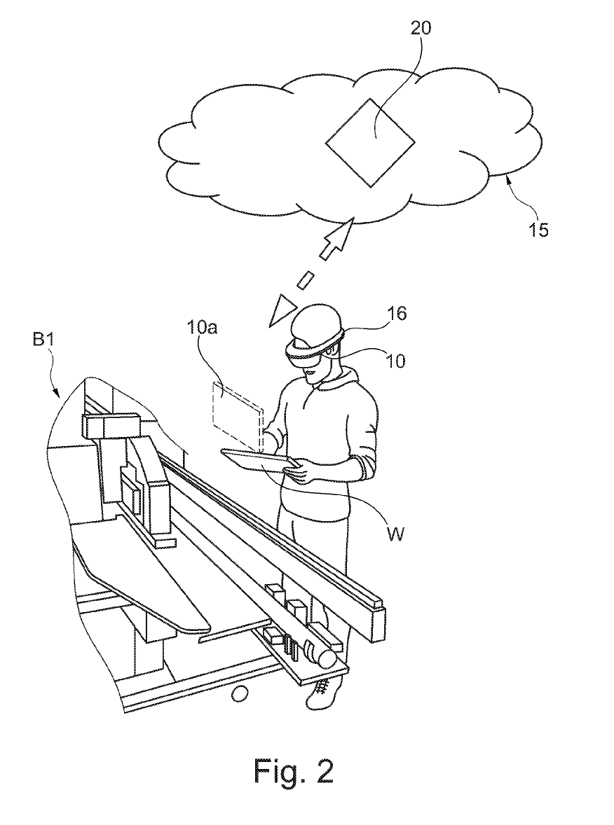

The system 1 comprises a mobile terminal device 10 which is configured to be worn by the operator. The mobile terminal device 10 can be a smart device such as a smartphone or a tablet computer, for example. Alternatively or additionally, the mobile terminal device can, for example, also be realized as so-called smart glasses which are configured to be worn on the head or on another body part of the operator. In this case, the mobile terminal device 10 has means 16, as shown in FIG. 2, for the terminal device 10 to be worn on the body of the operator, in particular on the arm or in the area of the head.

The mobile terminal device 10 first comprises position detection means 11 which are configured to detect data for determining the position of the mobile terminal device 10 in relation to the processing apparatus B1, B2, B3. In this manner, the position detection means 11 can have a camera or a similar sensor, for example. Alternatively or additionally, the position detections means 11 can also have, for example, a module for a global or local positioning system, with which the position of the mobile terminal device 10 can be inferred by means of the transmission data of various transmitters (satellites or local transmitters, for example). In this manner, it becomes possible to constantly determine at which precise location the mobile terminal device 10 is in relation to the processing apparatus B1, B2, B3.

The mobile terminal device 10 moreover comprises information output means 12 which are configured to output information and/or operational instructions to the operator. The information output means can be, for example, image output means, sound output means and touch output means, in particular vibration output means. The image output means can thereby include at least one virtual or projected representation 10a which is illustrated in FIG. 2 and will be described in more detail below.

The information output means 12 serve to output information and/or operational instructions for the respective operator with reference to the processing apparatus B1, B2, B3. The operator can thus be assisted in various ways. For example, the operator can be trained for the respective processing apparatus or can generally be provided with assistance in the operation, error recognition, troubleshooting, repair or maintenance. The information and/or operational instructions are thereby advantageously output together and with reference to an actual or virtual representation of the processing apparatus B1, B2, B3.

This can specifically mean that, on the one hand, the information or operational instructions and, on the other hand, the relevant components or area of the corresponding processing apparatus are shown together, for example, in an image representation and linked to one another. Consequently, not only is the user given a specific information or operational instruction, but rather he also obtains a direct representation to which area or component of the respective processing apparatus this information or operational instruction relates. Step-by-step instructions are thereby also conceivable in which an adapted image representation of the processing apparatus is shown for each further step and placed in relation to the respective information or operational instructions.

Various combinations of information outputs are certainly also possible, with the respective information output (for example voice output or vibration output) being linked to an actual or virtual representation of the processing apparatus. For example, a customized voice text can be output or an expedient touch/vibration output can occur, depending on the displayed section or component.

The mobile terminal device 10 moreover comprises a data transmission interface 13 which is configured to communicate with a data server 20 and is realized as a wireless data transmission interface in the present embodiment. The object of the data transmission interface 13 is, among others, to transmit position data detected by the position detection means 11 to the data server 20 and/or to receive information and/or operational instructions obtained from the data server 20 for transfer to the information output means 12.

In the present embodiment, the information respectively required for the information output is stored on the data server 20 and is transmitted in a customized manner to the information output means 12 of the mobile terminal device 10 via the data transmission interface 13. However, in order to give the operator even stronger possibilities of influencing the provision of information and/or operational instructions, the mobile terminal device 10 further has input means 14 which serve to receive inputs regarding the operator for transfer to the data transmission interface 13 as well as to the data server 20. This results in an interactive system in which the operator is in constant interaction and cooperation via the data server 20 with the system 1 according to the invention for the virtual assistance of the operator.

The input means 14 can have, for example, touch input means such as a keyboard or a touchscreen, sound input means, including voice recognition means, or also motion detection means such as gesture detection means or a virtual touchscreen.

As can be seen in FIG. 1, this results overall in a complete system in which the data server 20 communicates via the data connections 15 with the mobile terminal device 10 as well as with the processing apparatus B1, B2, B3, with at least one processing apparatus B1, B2, B3 having a machine data transmission interface for this purpose. The data server 20 in such a complete system can be located both locally, for example within a local network, as well as “remotely”. In the latter case, the data server 20 can be connected via the Internet, for example, with it being said in this case that the data server 20 is located in the so-called “cloud”.

The operation of the system according to the invention proceeds as follows, for example. As shown in FIG. 2, an operator is in the area of a processing apparatus B1 in order to carry out a specific operational process at the processing apparatus B1, for example, to place a workpiece W in the processing apparatus B1 in a specific manner. For the assistance thereof, the operator is equipped with the mobile terminal device 10 in the form of smart glasses which he wears on his head by means of the temples 16. In addition to various displays in the area of the lenses, the smart glasses 10 are configured to also generate a virtual display 10a which appears in the operator's field of vision. This virtual representation 10a can also be used as input means via a gesture control.

The complete system recognizes the current position of the operator or of the mobile terminal device 10 by way of the position detection means 11, and is moreover informed of the current state of the processing apparatus B1 as well as the future processing processes owing to the connection to the machine data interface of the processing apparatus B1. As soon as the operator has signaled his readiness to receive information and/or operational instructions by way of appropriate inputs or predefined behavior, the data server 20 sends respective information or operational instructions to the mobile terminal device 10 such that these are displayed, for example, in the area of the lenses or in the area of the virtual representation 10a of the mobile terminal device 10.

Not only can isolated information and/or operational instructions be thereby displayed to the user, but rather they can be placed in direct relation to the respective processing apparatus B1. Thus, the operator can be shown, for example, in a direct link to the processing apparatus, in which area and with which spatial orientation the workpiece W is to be fed into the processing apparatus B1.

As soon as the operator has performed this process, the completion of this process can occur automatically again through appropriate means or also through an explicit or implied confirmation by the operator. In this respect, the mobile terminal device 10 can also be used for controlling the processing apparatus B1 to a certain extent, possibly also very extensively, although this presently does not have to be the main purpose.

In further steps, the operator can consult a wide variety of information or operational instructions, and select these by way of the input means 14. For example, tutorials can be displayed to the operator, which in turn can be displayed in direct connection with the respective processing apparatus B1, B2, B3. The operator can also request direct assistance for troubleshooting or repair of the processing apparatus in the event of problems arising, and also be guided step-by-step through the required individual measures.

In a preferred embodiment, the operator can also retrieve information or operational instructions relating to an area of the processing apparatus, which is not visible in the assembled state of the processing apparatus B1, B2, B3. For example, it can be displayed upon the operator's request, which components are within a closed housing and with which measures the operator can possibly acquire access to these components. The operator can, for example, also be given an exploded view representation of specific components or areas which in turn can be linked to information or operational instructions regarding which areas or (individual) components are to be treated (replaced, for example). In this regard, the respective information or operational instructions can be represented, for example, in the form of individual images, image sequences as well as video sequences, and can be linked to the respective areas or components of the corresponding processing apparatus B1, B2, B3, depending on the need and comprehensibility.

What is claimed is:

1. A system for the virtual assistance of an operator of a processing apparatus for processing workpieces, comprising:
a mobile terminal device which is configured to be worn by the operator, and that has:
position detection means which are configured to detect data for determining the position of the mobile terminal device in relation to the processing apparatus;
information output means which are configured to output information and/or operational instructions to the operator; and
a data transmission interface which is configured to communicate with a data server.

2. The system according to claim 1, wherein the data transmission interface is configured to transmit position data detected by the position detection means to the data server and/or to receive information and/or operational instructions obtained from the data server for transfer to the information output means.

3. The system according to claim 1, wherein the information output means are configured to output information and/or operational instructions with reference to the processing apparatus.

4. The system according to claim 1, wherein the information output means are selected from image output means, sound output means and touch output means.

5. The system according to claim 4, wherein the image output means include at least a virtual or projected representation.

6. The system according to claim 1, wherein the mobile terminal device has input means which are configured to receive inputs of the operator for transfer to the data transmission interface as well as to the data server so as to control the receipt of information and/or operational instructions.

7. The system according to claim 6, wherein the input means are selected from touch input means sound input means, and motion detection means.

8. The system according to claim 1, wherein the position detection means are selected from a camera sensors, including thermal sensors or gyrosensors, laser scanners, as well as a global or local positioning system.

9. The system according to claim 1, wherein the terminal device has means for the terminal device to be worn on the body of the operator.

10. The system according to claim 1, further comprising:
at least one processing apparatus for processing the workpieces, and
a data server which communicates with the data transmission interface via a data connection.

11. The system according to claim 10, wherein at least one processing apparatus has a machine data transmission interface which communicates with the data server via a data connection.

12. A method for the virtual assistance of an operator of a processing apparatus for processing workpieces, by using a system according to claim 1, having the steps:
detection of data for determining the position of the mobile terminal device in relation to the processing apparatus by way of the position detection means,
transfer of the data to the data server via the data transmission interface,
receipt of information and/or operational instructions from the data server and output of information and/or operational instructions by way of the information output means.

13. The method according to claim 12, wherein the information and/or operational instructions obtained from the data server are displayed by way of the information output means, which are selected by way of input means.

14. The method according to claim 12, wherein the information and/or operational instructions relate to an actual or virtual representation of the processing apparatus.

15. The method according to claim 14, wherein a virtual representation includes at least an area of the processing apparatus, which is not visible in the assembled state of the processing apparatus.

16. The method according to claim 13, wherein the information and/or operational instructions output by way of the information output means include individual images, image sequences and/or videos.

17. The system according to claim 1, wherein the workpieces consist at least in sections of wood, wood materials or synthetic material.

18. The system according to claim 1, wherein the data transmission interface is wireless.

19. The system according to claim 3, wherein the information output means is configured to output the information and/or operational instructions together and with reference to an actual or virtual representation of the processing apparatus.

20. The system according to claim 4, wherein the touch output means comprise vibration output means.

21. The system according to claim 7, wherein the touch input means comprise a keyboard or a touch screen, the sound input means comprise voice recognition means, and the motion detection means comprise gesture detection means or a virtual touchscreen.

22. The system according to claim 8, wherein the camera is a CCD camera.

23. The system according to claim 9, wherein the means is for the terminal device to be worn on the arm or in the area of the head of the operator.

24. The system according to claim 11, wherein the machine data transmission interface communicates with the data server via the Internet.

25. The method according to claim 14, wherein the information and/or operational instructions are output together with the actual or virtual representation of the processing apparatus.
